(19) United States
(12) Patent Application Publication
(10) Pub. No.: US 2006/0267788 A1
(43) Pub. Date: Nov. 30, 2006

(54) Method and apparatus for illuminating a wall plate

(76) Inventor: George B. Delany, Rehoboth, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/336,613

(22) Filed: Jan. 20, 2006

Related U.S. Application Data
(60) Provisional application No. 60/645,786, filed on Jan. 21, 2005.

(51) Int. Cl. G09F 9/33

(52) U.S. Cl. 340/815.45

(57) ABSTRACT

A wall plate assembly configured to be arranged with a wall mounted switch or electrical outlet is illuminated in a manner at least some light is totally internally reflected. Various lighting effects may be produced by the wall plate assembly. An integral light source, such as LED(s), may be employed. An image may be applied to the wall plate assembly in a static or dynamic manner and be illuminated by the light source directly or by the internally reflected light. The wall plate assembly may include electronics that control the light source or image and may receive data for controlling the light source or image data via a communications interface.

### RELATED APPLICATIONS

This application claims the benefit of U.S. Provisional Application No. 60/645,786, filed on Jan. 21, 2005. The entire teachings of the above application are incorporated herein by reference.

### BACKGROUND OF THE INVENTION

Wall plates for switches or electrical outlets are generally white or a color designed to blend in with or otherwise complement the color of a wall. One function of a wall plate is to cover an unsightly hole in a wall into which a junction box supporting a switch (e.g., a light switch) or an electrical outlet has been installed. By covering the hole, the wall plate also prevents electrical shock. Wall plates are mundane, static devices providing little more than a safe covering for a hole in a wall.

### SUMMARY OF THE INVENTION

A wall plate arranged with a wall mounted switch or an electrical outlet may be transformed through use of embodiments of the present invention to provide a static or dynamic lighting effect that optionally illuminates static or dynamic images.

A wall plate assembly according to one embodiment of the present invention includes a light source and a wall plate configured to be arranged with a switch or an electrical outlet. In this embodiment, the wall plate is further configured to: (i) receive light from the light source, (ii) reflect at least a portion of the received light off an internal side of its front surface, and (iii) direct at least a portion of the internally reflected light in a direction observable to a person looking at the wall plate.

In one particular embodiment, the light source includes at least one Light Emitting Diode (LED). In other embodiments, the light source may include at least one incandescent or electroluminescent lamp. Alternative embodiments include a combination of LEDs, incandescent, or electroluminescent lamps.

The light source may be adapted to be powered by at least one of the following sources of power: line voltage associated with the wall mounted switch or electrical outlet, transformed line voltage, rectified line voltage, or a self contained power source (e.g., a battery).

By combining the wall plate and the internally reflected light, the wall plate may be useful as a wall decoration, expressive to a person observing the wall plate, or provide an emergency function or other function, such as illuminating a particular color in event of an alarm. An expressive quality of the wall plate may be created in part by the lighting or by at least one physical characteristic of the wall plate, such as shape, dimension, material, optical characteristics, or texture. The expressive quality of the wall plate may alternatively be a combination of the aforementioned physical characteristics.

In addition to the light source and the wall plate, the wall plate assembly in one embodiment includes an image that is illuminated by the internally reflected light. The illuminated image may be applied to a surface of the wall plate as a design element selected from a group consisting of: an image adhered to the surface of the wall plate, a sculpted image extending outwardly from the surface of the wall plate, a sculpted image extending inwardly from the surface of the wall plate, and a printed element printed on the surface of the wall plate. Alternatively, the illuminated image is applied beneath a front surface of the wall plate.

In an alternative embodiment, the illuminated image may be applied dynamically. Accordingly, in such an embodiment, the wall plate assembly may further include electronics configured to control an appearance of the illuminated image and, in some embodiments, to receive data from an external electronic device. The received data may be related to the appearance of the illuminated image. In one particular embodiment, the image is applied dynamically to an image display area, such as on Liquid Crystal Display (LCD) or other display.

Examples of images that can be applied statically or dynamically to the wall plate are creative text (e.g., corporate logos), icons (e.g., the flag of the United States of America), images of cities or historical locations, images of friends or family, cultural images, such as sports images, hobby images, such as fishing, hunting, boating, flying, or other images such as safety, health, and security. Applied images may even be clocks or schedule reminders. It should be understood that almost any geographical, cultural, story-telling theme, and so forth, can be applied to the wall plate.

In addition to the light source and the wall plate, the wall plate assembly in one particular embodiment includes control logic programmed to control the light source. The control logic may be addressable by a remote network node and programmable by the network node via a network communications path. The wall plate assembly in another embodiment includes an interface adapted to receive light source control data from an electronic device via any one of the following communications paths: radio frequency (RF) wireless, optical wireless, wired, or power line.

In some embodiments, a processor integrated with the wall plate assembly can perform bidirectional communications to report status information, such as light source failure, line power failure, low battery indicator, light switch on/off, or electrical outlet in use.

In addition to images, the wall plate may also include electronics and a speaker for producing sounds, optionally associated with image(s). The wall plate may have a light-sensor or user control feature that triggers its associated light to illuminate the wall plate material (e.g., plastic or glass), cause image(s) to be displayed, or cause any other functional or aesthetic effect(s).

Although described herein as applied to a wall plate for a switch or an electrical outlet, the wall plate assembly and embodiments associated therewith according to the principles of the present invention may be applied to other wall fixtures, such as light fixtures, utility panel doors, door knob fixtures, or other wall fixtures that are generally unused for such purposes.

Through use of embodiments of the present invention, the wall plate assembly may be employed as a light source, artistic medium, electronic palette, billboard, mini-cinema screen, or other description that applies in a particular context or application.

### BRIEF DESCRIPTION OF THE DRAWINGS

FIG. 1 is an illustration of a wall of a room with cover plates associated with a typical wall mounted switch used to control a ceiling fan/light combination and with wall mounted electrical outlets through which a floor lamp and a desktop computer receive power.

FIG. 2A is a perspective view of an exemplary wall plate configured to be arranged with a wall mounted switch or an electrical outlet in accordance with an embodiment of the present invention;

FIG. 2B is a perspective view of the exemplary wall plate of FIG. 2A configured with an illumination area in accordance with an embodiment of the present invention;

FIG. 2C is an exploded view of an exemplary configuration having a wall plate configured to be arranged with a switch in accordance with an embodiment of the present invention;

FIG. 2D is an exploded view of an exemplary configuration having a wall plate configured to be arranged with an electrical outlet in accordance with an embodiment of the present invention;

FIG. 3A is a top view of exemplary wall plate of FIG. 2A illustrating a rear side configured to receive light from a light source in accordance with an embodiment of the present invention;

FIGS. 3B-3I are top views of other exemplary configurations of the rear side in accordance with various embodiments of the present invention;

FIG. 4A is a top view of the exemplary wall plate of FIG. 2A illustrating a front side reflecting or transmitting light in accordance with one embodiment of the present invention;

FIGS. 4B-4C are top views of exemplary configurations of the front side in accordance with various embodiments of the present invention;

FIG. 5A is a ray diagram illustrating the principle of total internal reflection of light in an optical medium (e.g., glass or plastic);

FIGS. 5B-5E are top views of exemplary configurations of the front side in accordance with various embodiments of the present invention;

FIG. 6A is a top view of exemplary wall plate of FIG. 2A illustrating the front side allowing light to exit in accordance with an embodiment of the present invention;

FIGS. 6B-6F are top views of exemplary configurations of the front side allowing light to exit in accordance with various embodiments of the present invention;

FIG. 7A is a top view of the exemplary wall plate of FIG. 2A with an image and image viewing side in accordance with an embodiment of the present invention;

FIG. 7B is a top view of the exemplary wall plate of FIG. 2A illustrating an image visible through the front side in accordance with an embodiment of the present invention;

FIGS. 7C-7G are perspective views of various exemplary images applied to, and visible through or at, the front side in accordance with various embodiments of the present invention;

FIGS. 8A-8C illustrates example embodiments and orientations of light sources used in the wall plate assembly;

FIG. 9A is a side view of the exemplary wall plate of FIG. 2A with a imaging unit applying a loadable image onto a loadable imaging side in accordance with an embodiment of the present invention;

FIG. 9B is a perspective view of an exemplary application in which an image can be selectively loaded and displayed in accordance with one embodiment of the present invention;

FIG. 10A is a block diagram of an exemplary wall plate assembly including a light source, wall plate, and control logic for controlling the light source in accordance with embodiments of the present invention;

FIG. 10B is a block diagram of an exemplary wall plate assembly including the light source, wall plate, and control logic of FIG. 10A and an interface adapted to receive light source or image control data in accordance with embodiments of the present invention; and

FIG. 10C is a network diagram of the exemplary wall plate assembly of FIG. 10B including addressable control logic and an interface adapted to interface with a network in accordance with an embodiment of the present invention;

FIG. 11 is a block diagram of an example system employed in an embodiment of a wall plate assembly that controls light source(s) or images in the wall plate assembly.

### DETAILED DESCRIPTION OF THE INVENTION

A description of preferred embodiments of the invention follows.

A traditional wall plate for a switch or an electrical outlet utilized to cover a hole in the wall, is illuminated so as to become a source of light itself. In illuminating the wall plate, what was once static and mundane now becomes useful to a person observing the wall plate.

For the sake of readability, the term “wall plate,” as used herein, describes a wall plate for at least a switch and an electrical outlet. However, in some embodiments, a wall plate according to the principles of the present invention can be applied to other wall fixtures or non-wall fixture applications.

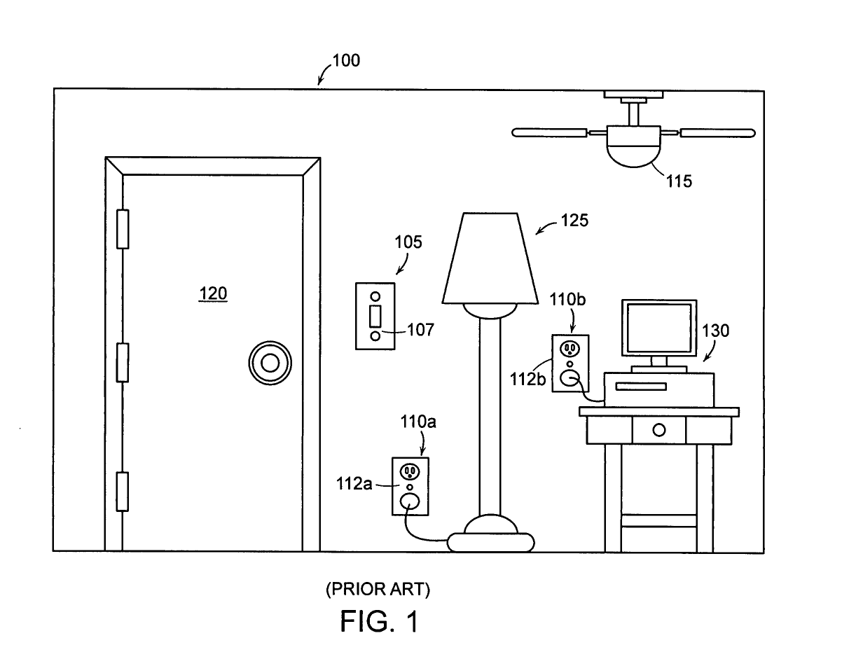

FIG. 1 illustrates a room wall 100 with a switch 105 and electrical outlets 110a and 110b. The location of the switch 105 depends largely on what electrical fixture is being controlled by way of the switch 105. In the case of switching a ceiling fan/light combination 115, it is convenient to locate switch 105 near an entranceway 120 at an accessible height. Similarly, the locations of the electrical outlets 110a, 110b typically depend on what appliance is being powered. In the case of a floor lamp 125, it is more convenient to locate the corresponding electrical outlet 110a near floor level. In the case of a desktop computer and monitor 130, it is more convenient to locate the corresponding electrical outlet 110 at desk level. Building codes may also dictate the location of the switch 105 and electrical outlets 110a, 110b.

Wall plates 107 and 112a, 112b are arranged with (i.e., positioned in a mated manner) with the switch 105 and electrical outlets 110a, 110b. The function of traditional wall plates include, covering unsightly holes in the wall 100 made to install the switch or electrical outlet, and providing safety and security, e.g., by insulating against electric shock.

In accordance with the embodiments of the present invention, a wall plate can be used to cover a hole in the wall 100 traditional wall plates and have other functions, such as providing useful information, acting as a vehicle for conveying an expression, idea, or meaning to a person viewing the wall plate, or be ornamental through addition of light or illuminated image(s). The light or image(s) may provide useful information to a person, such as an alert, event reminder, safety instruction, photographs, and so forth. For example, the wall plate may employ electronics to detect when a telephone rings and visibly indicate the ringing.

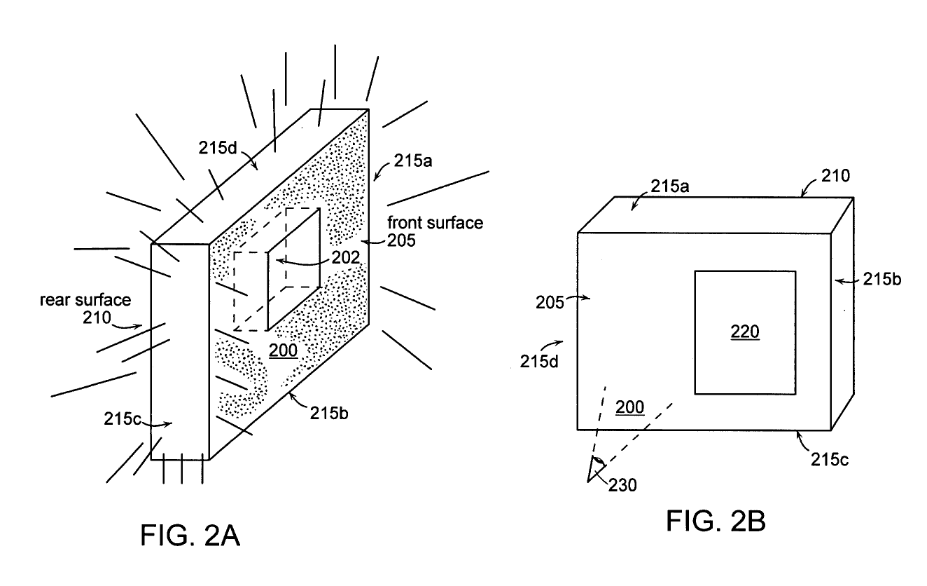

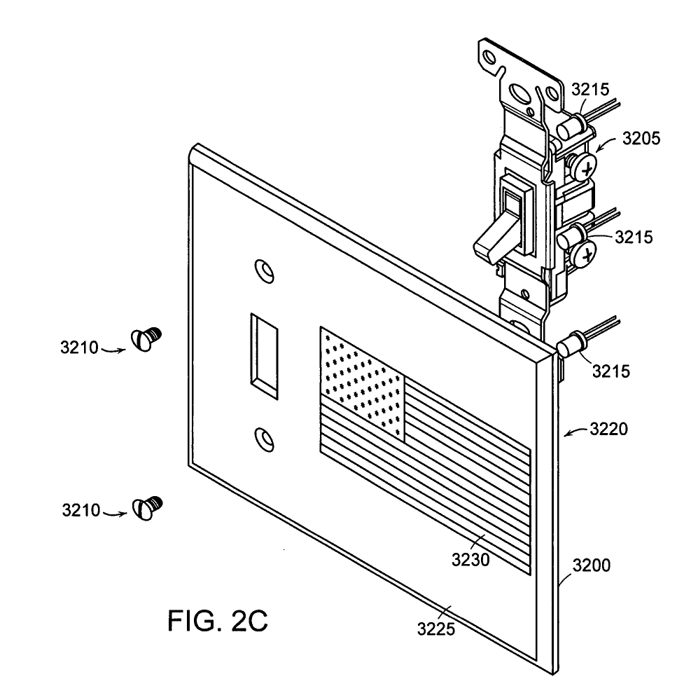

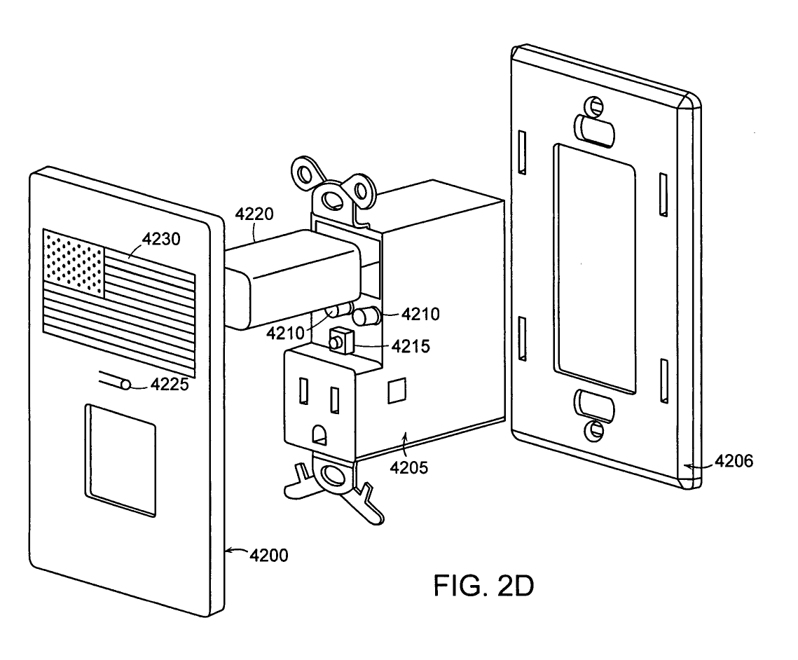

FIG. 2A illustrates generally an illuminated wall plate (“wall plate”) 200 in accordance with an embodiment of the present invention. The wall plate 200 has a front surface 205, a rear surface 210, and defines a hole 202 through which a light switch or wall power outlet fits to allow physical access to the light switch or power outlet. When a person views the wall plate 200, the front surface 205 is observable to the person, while the rear surface 210 is not observable. The front surface 205 is separated from the rear surface 210 by the thickness of the wall plate, as illustrated by the thickness of the edges 215a-d.

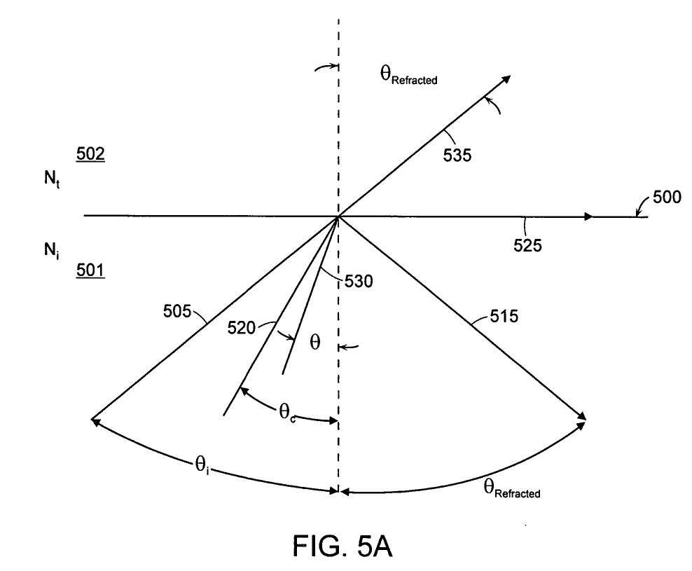

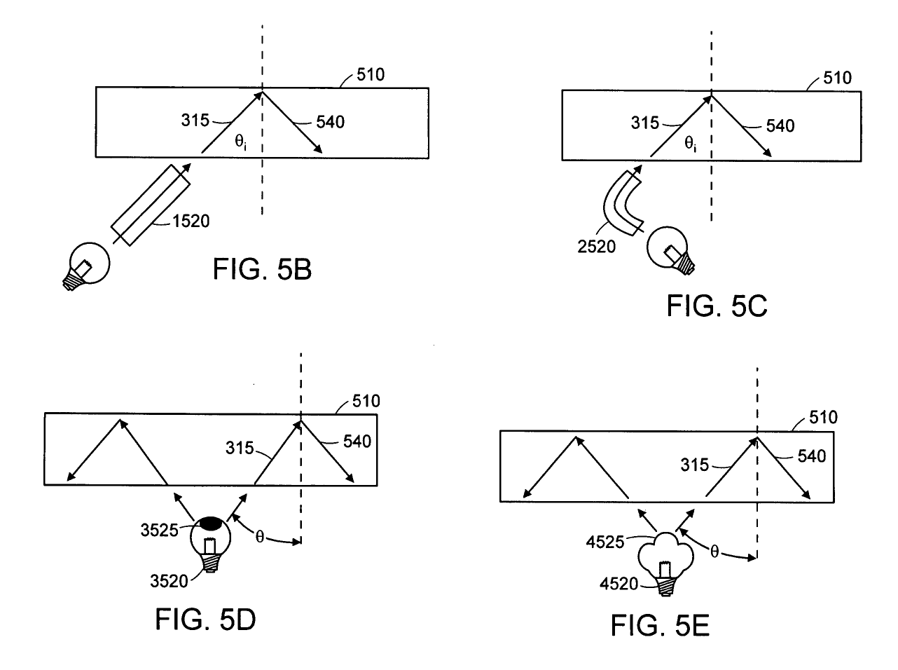

A light source (not shown), such as light emitting diodes (LEDs), may be employed to illuminate the wall plate 200 in a manner that causes at least some light to be temporarily captured by the wall plate 200 through total internal reflection principles, described in detail below in reference to FIGS. 5A-5D. The captured light can be directed so that it is observable by a person based on a physical shape of the wall plate 200 or based on optical properties (e.g., index of refraction) of material composing the wall plate 200. The light in the wall plate 200 may be directed out of the front surface, at least through one edge of the wall plate 200, through the rear surface, or combination thereof.

FIG. 2B is an alternative embodiment in which the wall plate 200 directs light out of an illumination area 220 in a direction observable to a viewer 230. While FIG. 2B illustrates the illumination area 220 as defining a portion of the front surface 205, the illumination area 220 may alternatively define a portion of the edges 215. One of ordinary skill in the art will readily appreciate the location of illumination area 220 may be provided at any portion of, or the entire, front surface or edge.

FIG. 2C illustrates an exemplary configuration having a wall plate 3200 configured to be arranged with a wall-mounted switch 3205. The wall plate 3200 is attached to the switch 3205 by fasteners 3210, such as screws. Typically, the switch 3205 is threaded to receive the fasteners 3210. Alternatively, the wall plate 3200 may be attached to the switch 3205 by non-mechanical fasteners, such as VELCRO®. The switch 3205 illustrated in FIG. 2C is merely exemplary. Other switches, such as paddle, push button, rotary, slide, touch sensitive, and so forth are also applicable as switches with which the wall plate 200 can be arranged.

FIG. 2C illustrates an embodiment in which a wall plate 3200 is illuminated by light sources 3215, such as LEDs. Light from the light sources 3215 enters the wall plate 3200 via its rear surface 3220 and at least partially reflects the light off of an internal side of the front surface 3225, causing the reflected portion to be trapped in the wall plate, at least temporarily. That is, before the light from the light sources 3215 reaches a viewer, the light is first trapped in the wall plate 3200 for a brief moment. In this embodiment, an American flag 3230 is adhered, printed, engraved, deposited in, or otherwise associated with the wall plate 3200, and the internally reflected light is directed through the American flag 3230, thereby producing an ornamental effect that is useful as a wall decoration. Other images may be useful for other reasons.

FIG. 2D illustrates an exemplary configuration having a wall plate 4200 configured to be arranged with an electrical outlet 4205. The wall plate 4200 may be attached to electrical outlet 4205 by fasteners (not shown). Typically, the electrical outlet 4205 may be threaded to receive the fasteners. Alternatively, the wall plate 4200 may be attached to the electrical outlet 4205 by non-mechanical fasteners, such as VELCRO®. In an alternative embodiment, the wall plate 4200 may be attached to the electrical outlet 4205 via an adapter plate 4206. In this embodiment, the adapter plate 4206 is configured to be mounted to a junction box (not shown) or other hardware located in the wall. The electrical outlet 4205 is in turn mounted to the adapter plate 4206. The wall plate 4200 is then “snapped” onto the adapter plate 4260. For example, wall plate 4200 is configured with peg(s) (not shown), which are securely held by mating hole(s) (not shown) on the adapter plate 4206. In this way, wall plate 4200 may be replaceable. An existing wall plate may be replaced with a new wall plate by simply unsnapped in the existing wall plate and snapping in the new wall plate. The electrical outlet 4205 illustrated in FIG. 2D is merely exemplary. Other electrical outlets, such as Type C (European 2-pin) and Type H (Israeli 3-pin) electrical outlets, are also applicable.

Continuing to refer to FIG. 2D, LEDs 4210 are employed to generate light that is captured and directed by the wall plate 4200 in a manner causing the wall plate 4200 to “glow” through at least some total internal reflection of the light. A push button switch 4215 may be employed to detect when the wall plate 4200 is secured in operative relationship with the electrical outlet 4205. Further, a battery or an AC-to-DC converter assembly 4220 may be employed to produce DC voltage to power or drive the LEDs 4210. Through use of the generated light, a graphic 4230 can be illuminated. A user control 4225 may be provided to facilitate selective control of the switch 4215.

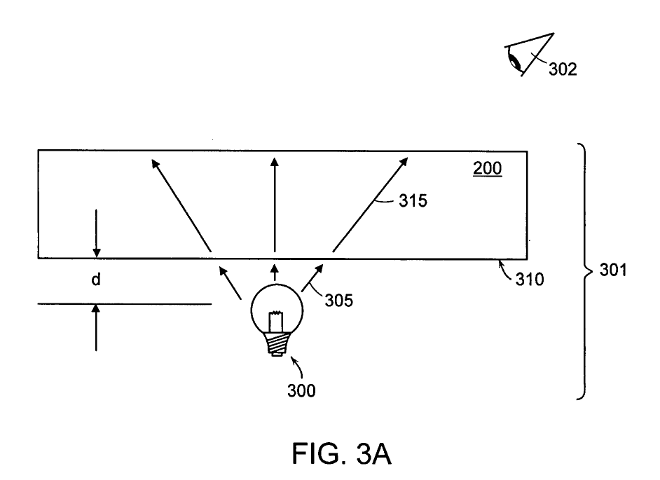

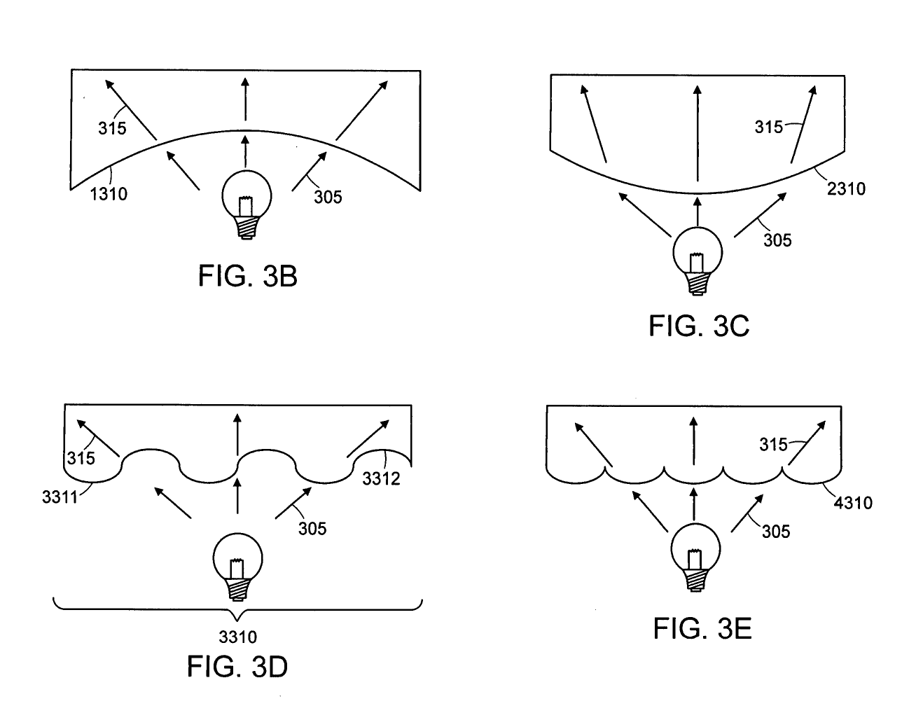

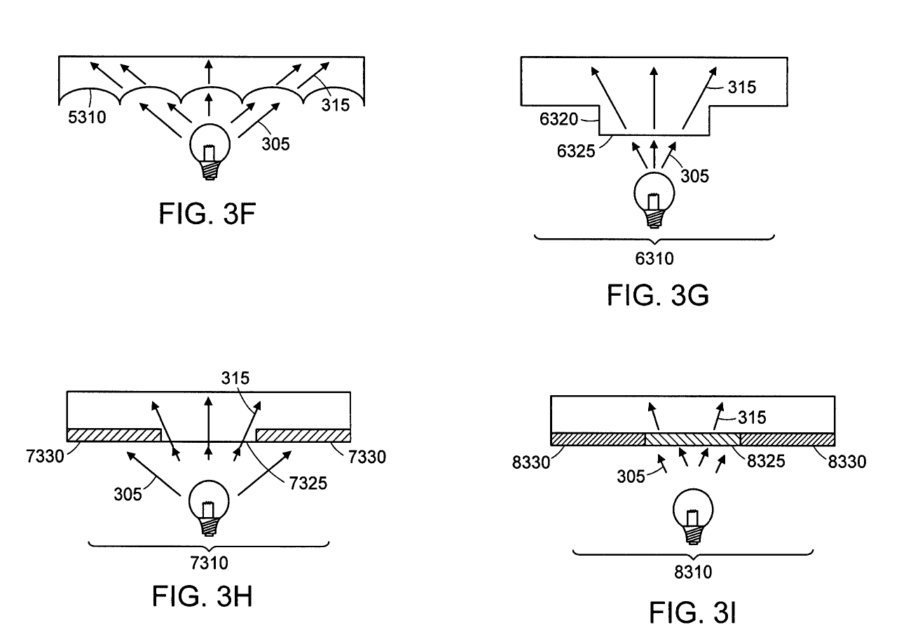

FIG. 3A is a diagram illustrating how light is received by a wall plate according to an embodiment of the present invention. To illuminate a wall plate 200 in a manner which can be useful as a wall ornament or cause the wall plate 200 to exhibit an expressive quality to a person viewing it, light is received by the wall plate 200 in a manner internally reflecting at least some of the light.

FIG. 3A illustrates an embodiment in which the wall plate 200 and a light source 300 form a wall plate assembly 301. The wall plate assembly 301 is viewed by a viewer 302. Provided light 305 from the light source 300 enters a light receiving side 310. The wall plate 200 is illuminated by the received light 315. The light receiving side 310 may be front surface 205, rear surface 210, edges 215, or any combination thereof. Alternatively, the light receiving side 310 may be a portion of front surface 205, rear surface 210, or edge 215.

The light source 300 may be spaced a distance “d” from the light receiving side 310. In one embodiment, the distance “d” is a positive distance, as shown in FIG. 3A. In another embodiment, the distance “d” is a zero or negative distance (not shown), i.e., the light source 300 and light receiving side 310 touch each other or the light source is positioned in a receptacle formed in the wall plate 200. The distance “d” may be selected to prevent early failure of the light source 200, to prevent damage to the light receiving side 310, or to prevent other undesirable effects which may be caused by heat generated by the light source 300.

FIGS. 3B-3H illustrate various exemplary light receiving sides. In FIG. 3B, provided light 305 is received by a substantially concave-shaped light receiving side 1310, resulting in received light 315 in the wall plate 1310. In FIG. 3C, the provided light 305 is received by a substantially convex-shaped light receiving side 2310, resulting in received light 315 in the wall plate. In another embodiment of the present invention, illustrated in FIG. 3D, the provided light 305 is received by a light receiving side 3310 having both convex regions 3311 and concave regions 3312, resulting in received light 315 in the wall plate. Alternatively, a light receiving side 4310 may have multiple convex regions only, resulting in received light 315, as shown in FIG. 3E. Furthermore, as shown in FIG. 3F, a light receiving side 5310 may have multiple concave regions only, resulting in a received light 315.

Referring to FIG. 3G, a light receiving side 6310 may further include a light receiving structure 6320. The light receiving structure 6320 includes, but is not limited to, light guides, light pipes, and light channels. The provided light 305 is channeled to the light receiving side 6310 by the light receiving structure 6320, resulting in a received light 315. In doing so, the light receiving structure 6320 defines a light receiving region 6325. The light receiving region 6325 may be a portion of the light receiving side 6310. In one embodiment, only the provided light 305 striking the light receiving region 6325 results in the received light 315, and the provided light 305 striking other portions of the light receiving side 6310 does not result in received light 315.

As shown in FIG. 3H, in addition to the light receiving structure 6320 of FIG. 3G, a light receiving region 7325 may be defined by at least one opaque region 7330. In FIG. 3H, the light receiving side 7310 includes a light receiving region 7325 flanked by opaque regions 7330 and 7330. The provided light 305 falling on the light receiving region 7325 results in the received light 315. In contrast, the provided light 305 falling on either opaque regions 7330 does not result in the received light 315.

FIG. 3I illustrates an alternative embodiment, in which a light receiving region 8325 is varied (e.g., voltage controlled dimming) to vary the amount of received light 315. For example, the light receiving region 8325 filters light as a function of voltage differential across it, so that only a portion of provided light 305 striking the light receiving region 8325 results in the received light 315. In this embodiment, the provided light 305 striking either of the opaque regions 8330 does not result in received light 315.

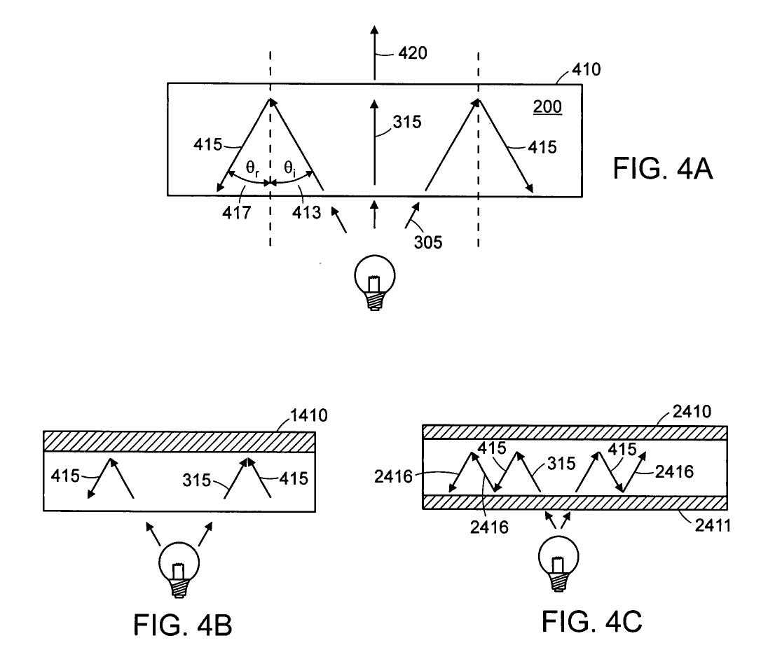

FIGS. 4A-4C illustrate internal reflection occurring inside the wall plate, as mentioned above. Referring first to FIG. 4A, after receiving light, the light is internally reflected in the wall plate 200. That is, light is reflected within and internal to the wall plate 200. Received light 315 striking a light reflecting side 410 at an angle of incidence 413 is reflected as internally reflected light 415 at an angle of reflection 417.

According to the principles of optical reflection, an angle of incidence 413 (i.e., an angle between a light ray incident on a surface and a line perpendicular to the surface at the point of incidence) and an angle of reflection 417 are equal. In the case where received light 315 strikes the light reflecting side 410 at an angle of incidence of zero (i.e., the received light 315 is perpendicular or normal to the light reflecting side 410), the light is not internally reflected, but rather transmits out of the wall plate as transmitted light 420. Consequently, a portion of the received light 315 striking the light reflecting side 410 may not be reflected as internally reflected light 415.

The light reflecting side 410 may be the inner side (also referred to as the internal side) of either the front surface 205, rear surface 210, edges 215 (FIG. 2A), or combination thereof.

In one embodiment of the present invention, the light reflecting side 410 is composed of or coated with a light reflective material, such as silver, mercury, iridium, dielectric coating, or reflective paint. The front surface 205 and rear surface 210 may be coated leaving an entry window (not shown), in which case, light entering the entry window exits the edges 215 or any area left uncoated.

FIG. 4B illustrates received light 315 striking a light reflecting side 1410 where the reflected light is referred to herein as internally reflected light 415. The internally reflected light 415 may exit the wall plate through its edge(s).

FIG. 4C illustrates, in addition to a first light reflecting side 2410, that there may be a second light reflecting side 2411. In FIG. 4C, the received light 315 striking upon the light reflecting side 2410 is reflected as internally reflected light 415, which, in turn, strikes the second light reflecting side 2411, and, in turn, is reflected as a secondary internally reflected light 2416. There may be n number of secondary internally reflected light 2416 sequences. While FIG. 4C illustrates light reflecting side 2410 and secondary light reflecting side 2411 as substantially parallel to one another, the present invention is not limited to such an arrangement. For example, the first light reflecting side 2410 and the second light reflecting side 2411 may be arranged so as to converge or nearly converge at a point (not shown).

In another embodiment of the present invention, the light reflecting side 410 reflects light as a result of an optical effect known as total internal reflection. The optical effect of total internal reflection occurs when light traveling in a first medium strikes a boundary with a second medium having a lower refractive index at an angle of incidence greater than or equal to a “critical angle” of the boundary. The critical angle of the boundary between the first medium and the second medium is dependent on the refractive indices of the two media.

FIG. 5A illustrates the optical effect of total internal reflection. In FIG. 5A, a boundary 500 separates a first medium 501 having a refractive index of nᵢ and a second medium 502 having a refractive index of nt. Refractive index nᵢ is greater than refractive index nt. Consequently, the boundary 500 has a critical angle θ_{critical} at which, and greater than at which, light does not pass from the first medium to the second medium, but, instead, the light reflects back into the first medium. For example, an incident ray 505 strikes the boundary 500 at an angle of incidence θᵢ greater than critical angle θ_{critical}. The incident ray 505 is internally reflected as an internally reflected ray 515 having an angle of reflection θ_{reflected}. A second incident ray 520 strikes the boundary 500 at an angle of incidence θ_{c} equal to critical angle θ_{critical}. The second incident ray 520 is reflected as a parallel ray 525, i.e., parallel to the boundary 500. A third incident ray 530 strikes the boundary 500 at an angle of incidence θ less than critical angle θ_{critical}. The incident ray 530 is refracted as a refracted ray 535 having an angle of refraction θ_{refracted}. Using the following equation, the critical angle θ_{critical} for the boundary 500 is determined from the refractive index of the first medium 501 (i.e., nᵢ) and the refractive index of second medium 502 (i.e., nₜ).
θ_{critical}=sin⁻¹(nᵢ/nₜ) Equation 1:

The following table lists θ_{critical} values for typical nᵢ−nₜ boundaries:

TABLE 1

| B 11346565.3 | | |
|---|---|---|
| Typical θ_{critical} Values for nᵢ-nₜ boundaries | | |
| incidence medium (nᵢ) | transmitting medium (nₜ) | critical angle (θ_{critical}) |
| flint glass = 1.50 | air = 1.00 | 42.81 |
| quartz = 1.54 | air = 1.00 | 40.49 |
| plastic = 1.59 | air = 1.00 | 38.97 |

FIGS. 5B-5D illustrate embodiments of the present invention which use the previously described optical effect of total internal reflection to internally reflect light by providing and/or receiving light at an angle of incidence θᵢ greater than the critical angle for the light reflecting side 510.

In FIG. 5B, a light receiving structure 1520 is used to ensure the received light 315 strikes the light reflecting side 510 at angle of incidence θᵢ, which exceeds the critical angle, causing the received light 315 to experience total internal reflection. While FIG. 5B illustrates light receiving structure 1520 as a linear form, the claimed invention is in no way limited by such a form. For example, in reference to FIG. 5C, a light receiving structure 2520 is an elbow-shaped form. One skilled in the art will readily recognize any form which ensures the received light 315 strikes the light reflecting side 510 at angle of incidence θᵢ greater than the critical angle.

In FIG. 5C, a capped light source 3520 provides light in a manner that the received light 315 strikes the light reflecting side 510 at angle of incidence θᵢ. The capped light source 3520 includes a capped region 3525, which eliminates light which strikes light reflecting side 510 at an angle of incidence less than the critical angle for the light reflecting side 510.

In FIG. 5D, a shaped light source 4520 provides light in a manner that received light 315 strikes the light reflecting side 510 at angle of incidence θᵢ. The shaped light source 4520 includes a shaped region 4525, which eliminates light that strikes the light reflecting side 510 at an angle of incidence less than the critical angle for the light reflecting side 510.

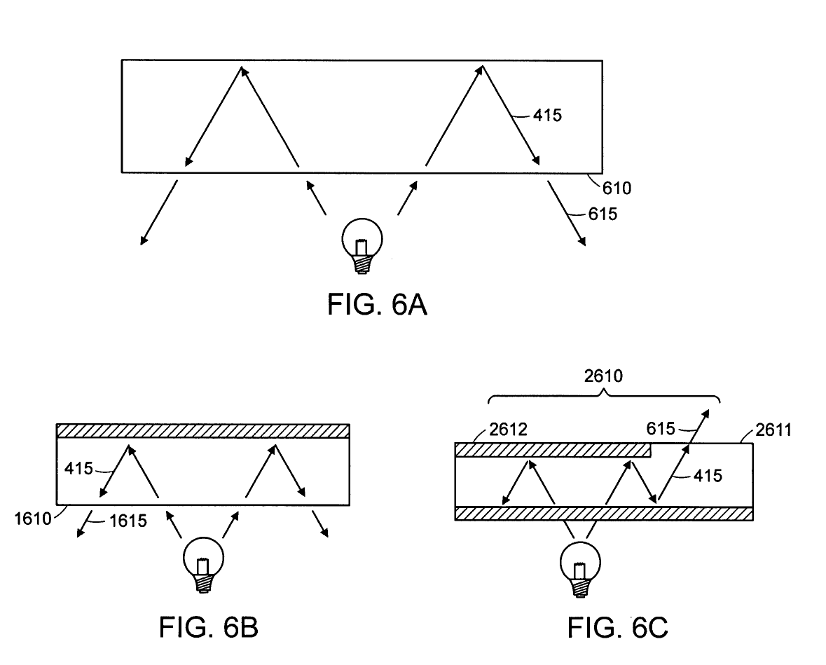

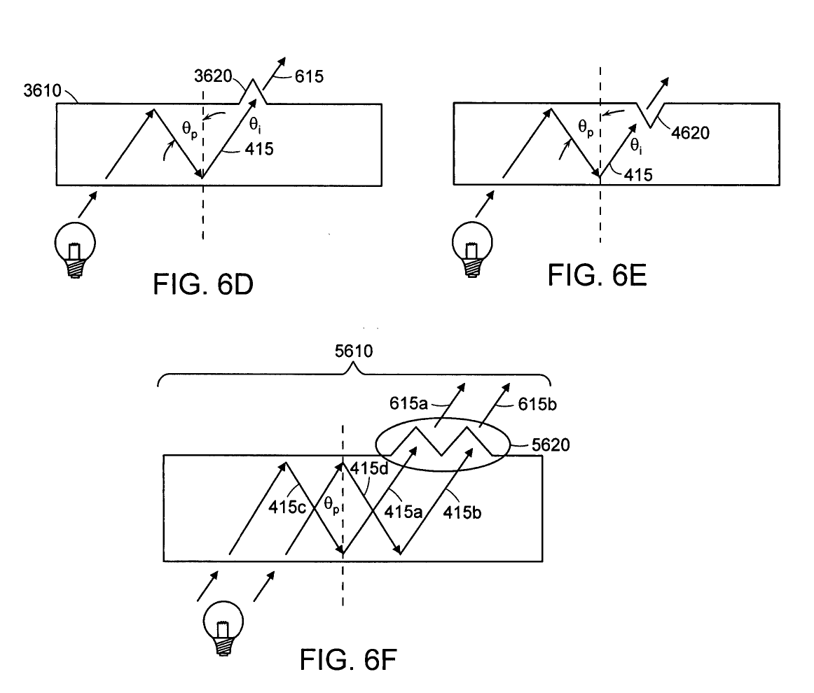

FIGS. 6A-6F illustrate example techniques of directing light from the wall cover to be observable by a person looking at the wall cover. After receiving and internally reflecting light, the wall plate 200 directs the light outward in a direction observable to a person viewing the wall plate 200. Referring to FIG. 6A, internally reflected light 415 is directed toward a light exiting side 610, resulting in a directed light 615. The directed light 615 may be observable to the person directly. Alternatively, the light can be directed in a manner causing a silhouette or halo effect. For example, the light can be directed at the wall to cause a halo effect around the wall plate. The light can also be directed between the wall and the wall plate to cause the wall plate in front of the lighting to appear as a dark shape or a “silhouette.” The light exiting side 610 may be the inner side (also referred to as the internal side) of either the front surface 205, rear surface 210, edges 215 (FIG. 2A), or combination thereof.

FIG. 6B illustrates an embodiment in which a light exiting side 1610 comprises a material that transmits internally reflected light 415 without reflecting it. Accordingly, the internally reflected light 415 striking the light exiting side 1610 is transmitted as a directed light 1615.

FIG. 6C illustrates another embodiment of the present invention in which a light exiting side 2610 includes a transmitting portion 2611 and a non-transmitting portion 2612. Internally reflected light 415 striking the transmitting portion 2611 is transmitted as a directed light 615 outward from the cover plate. In contrast, the internally reflected light 415 striking the non-transmitting portion 2612 is not transmitted. In this way, the internally reflected light 415 may be selectively transmitted as directed light 615 depending on what portion of the light exiting side 2610 the internally reflected light 415 strikes.

FIG. 6D illustrates yet another embodiment of the present invention in which a light exiting side 3610 includes a light directing structure 3620. Internally reflected light 415, reflected at a prior angle of incidence θₚ, strikes the light directing structure 3620 at the angle of incidence θᵢ. If the angle of incidence θᵢ is less than the critical angle θ_{critical}, the internally reflected light 415 is not reflected, but is transmitted as directed light 615. The light directing structure 3620 is structured such that internally reflected light 415—previously total internally reflected at angle of incidence θₚ (i.e., at an angle greater than the critical angle for light reflecting side 410)—now strikes the light directing structure 3620 at angle of incidence θᵢ. The light directing structure 3620 is structured as, for example, a wedge or a bump 4620. This structure allows the internally reflected light 415 to pass through the wedge 4620 without further internal reflection, thereby directing light out of the wall cover and in a direction observable by a person.

FIG. 6F illustrates another embodiment in which a light exiting side 5610 includes a region of light directing structures 5620. Internally reflected light 415a and 415b striking the region of light directing structures 5620 is transmitted as directed light 615a and 615b. The internally reflected light 415c and 415d does not strike the region of light directed structures 5620; thus, the prior angle of incidence θₚ remains unchanged. Consequently, the internally reflected light 415c and 415d is not transmitted, but is totally internally reflected instead (assuming the prior angle of incidence θₚ is greater than the critical angle θ_{critical}). In this way, the internally reflected light 415 may be selectively transmitted as directed light 615, depending on whether the internally reflected light 415 strikes the region of light directing structures 5620 or not. In some embodiments, text, graphic(s), visually ornamental image(s), or the like can be positioned to receive light output by the light directing structure 5620.

Embodiments of illuminating the wall plate 200 can be extended to include illuminating an image associated in optical arrangement with the wall plate 200.

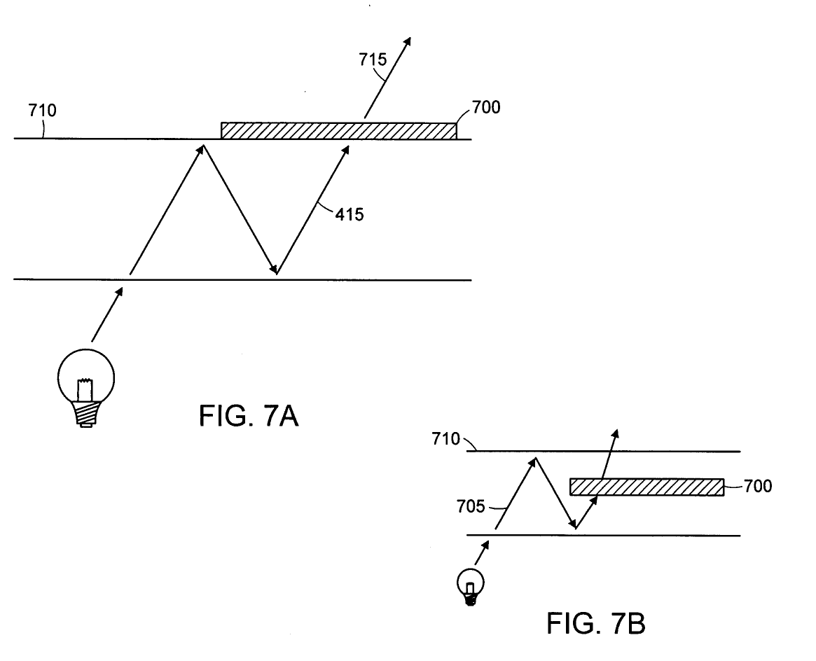

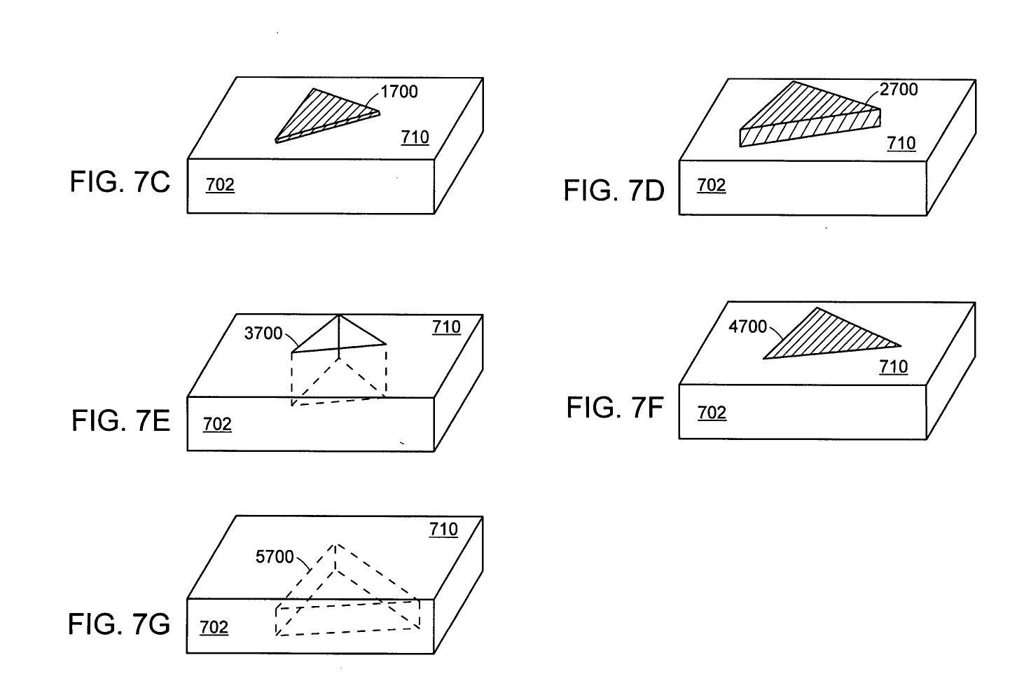

FIG. 7A illustrates an embodiment of the present invention which, in addition to including a light source and a wall plate, includes an image 700 applied to an image viewing side 710. The image viewing side 710 may be the front surface 205, rear surface 210, edges 215 (see FIG. 2A), or any combination thereof. The image 700 may be deployed on or composed of material(s) that change the angle of light internally reflecting in the wall plate. In other words, the index of refraction of the image 700 in combination with the index of refraction of the wall plate may cause the light to project outward from the image 700 toward a person viewing the wall plate. Thus, the image 700 is illuminated by the internally reflected light, and, optionally, illuminated by a light source directly.

FIG. 7B illustrates another embodiment of the present invention in which the image 700 is applied beneath the image viewing side 710, as shown in FIG. 7B. In such an example, the image 700 can be illuminated by the internally reflected light 705 and change its angle such that it passes through the image viewing side 710 to allow a person to view the illuminated image 700.

The principles previously described for illuminating a wall plate also apply to illuminating the image 700. Referring to FIG. 7A, the internally reflected light 415 strikes the image 700, which causes the internally reflected light 415 to change its angle of travel and pass out of the wall plate as observed light 715 in a direction observable by the person looking at the wall plate. Thus, the image appears illuminated with respect to areas of the wall plate that totally internally reflect the light.

The observed light 715 may vary as the internally reflected light 415 interacts with various or varying images. For example, the internally reflected light 415 having a first color may interact with the image 700 having a second color, resulting in the observed light 715 having a third color. Those familiar with lighting will readily recognize the additive and subtractive properties of light. In another example, the internally reflected light 415 having a first polarity interacts with the image 700 adapted to alter the polarity of light, resulting in the observed light 715 with another polarity. A polarizing medium may be employed to change the amount of light the person sees based on the difference in angle of polarization between the polarized light and polarizing medium, as understood in the art. In yet another example, the internally reflected light may interact with the image 700, which may be adapted to disperse light to produce multiple colors (e.g., a rainbow effect) in the observed light. In still another example, the internally reflected light 415 interacts with the image 700, which can be adapted to cause observed light 715 to exhibit interesting light effects, such as sparkling.

FIGS. 7C-7E illustrate various examples of how the image 700 can applied to the image viewing side 710 of a wall plate 702. In FIG. 7C, an image 1700 may be adhered onto the image viewing side 710. The image may be provided on a decal, for example. The image 1700 may be adhered permanently or temporarily. In the case of being adhered temporarily, there is an option for replacing the image with a different image. For example, there may be a series of images corresponding to various holidays or seasons of the year. In such an example, one can simply replace images with each changing holiday or season. It should be understood that the image is on a material or adhered by an optically transmissive substance that causes the internally reflected light to pass through the image 1700 to make it more visible to a person observing the wall cover.

FIG. 7D illustrates a sculpted image 2700 extending outwardly from an image viewing side 710. In one embodiment, the sculpted image 2700 extends outwardly from the image viewing side 710 only slightly (known as bas-relief or low relief). Alternatively, the sculpted relief image 2700 may extend outwardly from the image viewing side 710 significantly (known as high relief). The sculpted image 2700 may be molded, machined, applied, stamped, embossed or otherwise formed with the wall plate 702.

FIG. 7E illustrates a sculpted image 3700 extends inwardly from the image viewing side 710. The sculpted image 3700 may be molded, machined, stamped, debossed, or otherwise formed with the wall plate 702.

FIG. 7F illustrates a printed image 4700 printed onto the image viewing side 710. The printed image 4700 may be printed onto the image viewing side 710 using printing techniques known in the art, such as silk screening or ink-jet printing. Alternatively, the image 4700 may be imprinted into the image viewing side 710 using engraving techniques, such as mechanical, laser, ultrasonic, or chemical engraving.

FIG. 7G illustrates an embodiment which, in contrast to applying the image 700 to the image viewing side 710, applies an embedded image 5700 beneath the image viewing side 710. For example, the embedded image 5700 may be a standalone plastic tab that is embedded in an epoxy, glass, plastic, or other material forming the wall cover.

The image 700 may be textual (i.e., consist of alphanumeric characters) or graphical. For example, in one embodiment, the illustrated image 700 may be a biblical verse. In another embodiment, the image 700 may be an American flag. In addition to text and graphics, the image 700 may also be a logo. In yet another embodiment, the image 700 may be an icon or a symbol.

In an exemplary industrial application, the image 700 may provide information or a warning to workers of a dangerous situation (e.g., “fire alert”) or direct the workers to safety (e.g., “emergency exit route”). One of ordinary skill in the art will readily recognize the image 700 is not limited to the aforementioned exemplary embodiments.

The image 700 in some embodiments is substantially a two-dimensional object, while in others it is a three-dimensional object. The image 700 may be substantially colorless or colored. Additionally, the image 700 may be substantially tektureless or textured. Further, the image 700 may be static, selectable, or dynamic.

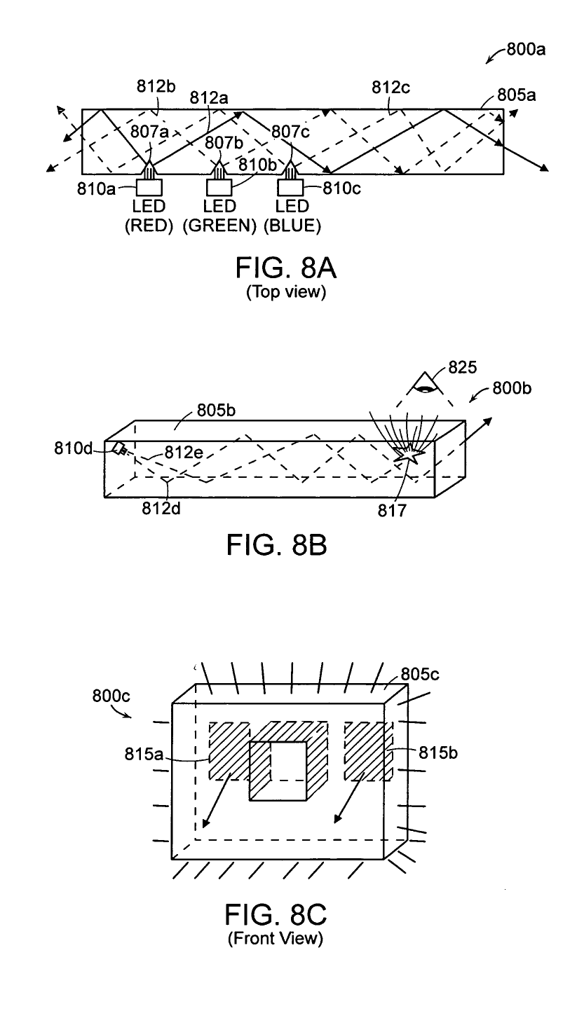

FIG. 8A is a top view of a wall plate assembly 800a in which a wall plate 805a receives multiple colors of light from three LEDs. The LEDs include a red LED 810a, green LED 810b and blue LED 810c. Respective wedges 807a, 807b, and 807c are formed in the wall plate 805a in a manner that causes light 812a, 812b, 812c from the LEDs to travel at an angle with respect to a surface opposite the LEDs that exceeds the critical angle. As a result, the light 812a, 812b, 812c travels internally in the wall plate 805a and exits through edges of the wall plate 805a.

FIG. 8B is a three-dimensional view of a wall plate assembly 800b that includes a wall plate 805b and a light emitting diode 810d, which directs light 812d into the wall plate 805b from an edge of the wall plate 805b at an angle that causes the light 812d to reflect internally through the wall plate 805b until it exits at the opposite edge from the edge it enters. A second beam of light 812e internally reflects in the wall plate 805b, but, upon striking a star 817 deposited in the wall plate 805b, the light 812e changes its direction and transmits through the front of the wall plate 805b such that an observer 825 clearly sees the star 817 due to illumination of the star 817 by the second beam of light 812e. It should be understood that any light contacting the star 817 or other internal structure may be directed through a front surface of the well plate 805b, thus producing an illuminating effect.

FIG. 8C is yet another embodiment of the wall plate assembly 800c in which another example of a light source 815a, 815b is provided. In this embodiment, the light sources 815a, 815b are two-dimensional arrays of light producing elements, such as LEDs or other elements that can generate light. In this case, the light sources 815a, 815b are arranged substantially flush with a rear surface of the wall plate 805c. Some of the light from the light sources 815a, 815b projects through the front surface of the wall plate 805c, and some of the light internally reflects in the wall plate 805c in a manner that causes the internally reflecting light to exit the wall plate 805c through the edges, as described above. Internally, but not shown in FIG. 8C, the wall plate 805c may have wedges or other light directing features that cause light from the optical sources 815a, 815b to internally reflect or project in such a way as to cause other interesting effects to occur in the wall plate 805c. Moreover, the light sources 815a, 815b may be controllable via microprocessor control and change intensity, frequency, or other light producing characteristics to cause other interesting effects to be observable by a person viewing the wall plate 805c.

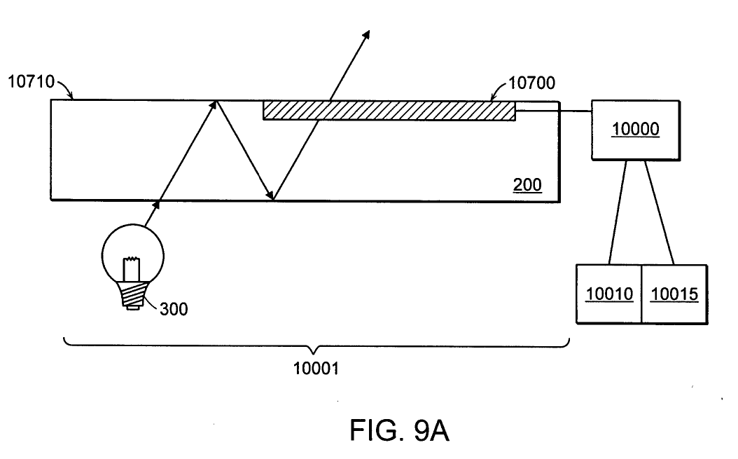

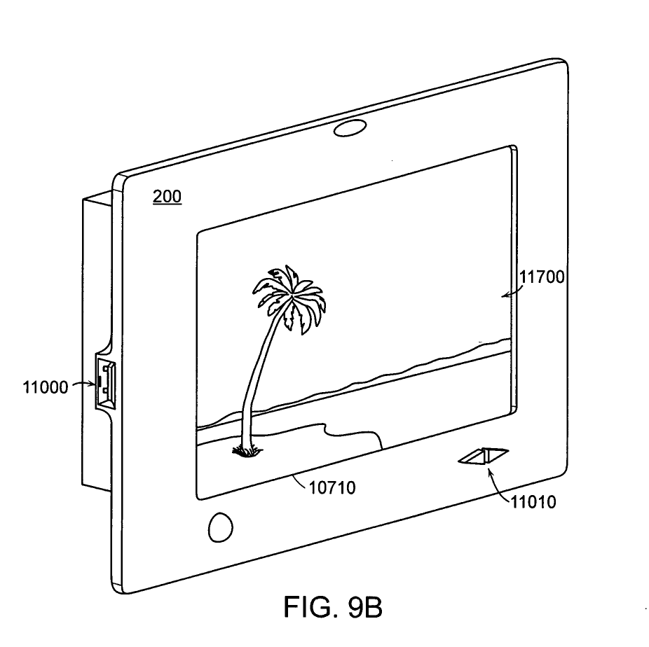

FIG. 9A illustrates a wall plate assembly 10001 that employs a dynamic image unit 10000 in the wall plate 200. The dynamic image unit 10000 allows for displaying an loadable image 10700 on a loadable image viewing side 10710.

The dynamic image unit 10000 may be loaded with the loadable image 10700 during production, one time burn-in, or dynamically by a user through the use of a data port (e.g., USB or FIREWIRE port) (not shown), by a wireless application, powerline communications (PLC), or some other means used for data transfer by electronics.

In one embodiment, the dynamic image unit 10000 further includes (i) a data storage area 10010 for storing loadable images and (ii) a control area 10015 for controlling the application of the loadable image 10700. Microprocessors or other electronics known in the art (e.g., analog circuitry, digital logic, or Field Programmable Gate Arrays (FPGAs)) adapted to support data transfer and processing may also be employed.

The loadable image viewing side 10710 may be the front surface 205, rear surface 210, edges 215, or any combination thereof. Alternatively, the loadable image viewing side 10710 may be a portion of front surface 205, rear surface 210, or edges 215. Furthermore, the loadable image viewing side 10710 may be a separately designed component part inserted into the wall plate 200 or a conductive material configured to load the loadable image 10700.

In one embodiment, the light source 300 may illuminate the loadable image 10700 applied to the loadable imaging side 10710, or it may support a different (e.g., external) light source (not shown) to illuminate the loadable image 10700 in the presence of the light source 300.

FIG. 9B illustrates an exemplary application in which the loadable image 11700 is a photograph. In this embodiment, one or several individual photographs can be loaded into an imaging unit (not shown) via a data port 11000 and applied to the loadable image viewing side 10710 as selected by a user viewing the wall plate 200 or from a remote location. Loading buttons 11010 (e.g., forward/back) may be provided on the wall plate 200 to allow the user to cycle through multiple stored photographs to preview and select the loadable image 11700. In an alternative embodiment, rather than the user having to select, load, and apply the loadable image 11700, a series of sequentially loadable images are loaded and applied to the loadable image viewing side 10710 for continuous display. In this way, the user can view a series of sequentially loadable images (e.g., video) as “live action” rather than “still life.”

In another exemplary application, the loadable image 10700 may be a “To Do” message or list from a user's Personal Digital Assistant (PDA) (not shown). The “To Do” message or list may be loaded into the dynamic image unit 10000 and applied to the loadable image viewing side 10710 in an automated manner. In this way, the user viewing the wall plate 200 is reminded of tasks to do.

In yet another embodiment, a combination of a lens assembly (not shown) and electronics (not shown) adapted to shift (temporarily or spatially) identical images may be employed, so that at a certain distance, the image appears to be three dimensional. In this way, a holographic image effect may be achieved.

The light source 300 may be an incandescent lamp or electroluminescent lamp. In one embodiment of the present invention, the light source 300 is a light emitting diode (LED) or multiple LEDs, optionally the same or multiple colors.

Features and mechanical durability benefits associated with use of an LED as the light source 300 include, but are not limited to: long-life, low heat output, dependable source of bright light, multiple possible shapes, different types of LED lens designs for different applications, diverse assortment of plastics available, design applications, consumption of less power than an incandescent lamp, less expensive to maintain than an incandescent bulb, options for indoor and outdoor applications, wide range of colors, and so forth. It should be understood that advantages are available with other light sources. LED technology benefits are presented here for example purposes only.

Various voltage LEDs, such as 1.5 volt LEDs, may be used. Other voltage LEDs (e.g., 3.0V and 4.5V) can be employed. A suitable power source or current supply may also be used with the LEDs or other light source in accordance with electrical engineering practices. A combination of different voltage LEDs may also be employed.

Stiff or flexible circuit boards (or other suitable substrates) can be used that might allow all kinds of new layouts economically in terms of mounting the LEDs or other light source.

The light source 300 may be a single lamp or multiple lamps. In the case of multiple lamps, each lamp may be bundled in one spot or distributed. Multiple lamps may be distributed to corners or on a horizontal and/or vertical axis of the wall plate 200. Alternatively, multiple lamps may be distributed, for example, in a geometric pattern, such as a circle or square, or outline a letterform, such as the initials “GBD” or an indicator, such as “EXIT →” or graphic illustrating same. As such, interesting or exciting “shows” which are expressive or of interest to a person viewing wall plate 200 can be generated in this fashion.

Some of the embodiments can be done using the light source 300 in a static configuration. In other embodiments, the light source 300 is used in a dynamic configuration. For example, the light source 300 may include one or more lamps, each producing a different color of light. These lamps can be programmed to put on different kinds of “shows.” In other words, programmed displays of lights may be performed by the wall plate 200.

In another example, the light source 300 may include one colored lamp for each primary color, namely, a red lamp, green lamp, or blue lamp. Using the principles of additive color mixing, other colors can be created from these three colored lamps. For example equal parts (i.e., equal intensity) of red light, green light and blue light create white light. By varying the intensity of each colored lamp, multiple colors can be created. Accordingly, these lamps can be programmed to vary in intensity, thereby creating a show of varying colors.

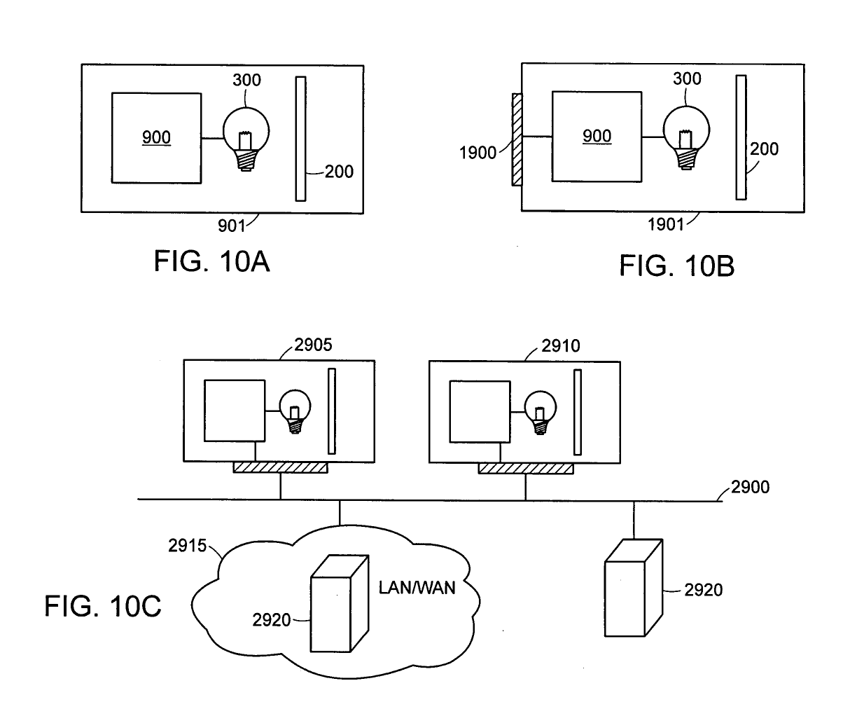

FIG. 10A illustrates an embodiment in which the wall plate 200 and light source 300 are controlled by control logic 900 to form a wall plate assembly 901. Controlling the light source 300 is yet another way an embodiment of the present invention provides a vehicle for making the wall plate 200 usefully ornamental or for conveying an expression or meaning to a person viewing the wall plate assembly 901.

The control logic 900 may be as simple as a mechanical or electronic switch that turns the light source 300 on, off, or at a level in-between. For example, a user depresses an on/off button to control the light source 300. In another example, a light sensor, such as photocell, detects ambient light levels and controls the light source 300, accordingly.

In one embodiment, the control logic 900 may be a conductive ink switch, where the conductive ink may be printed onto the wall plate 200. When a person touches the conductive ink, the action causes a switch to close. Other functions described herein may also be printed onto the wall plate 200 in the form of icons or other suitable marks. Touch screen or other user-friendly switch mechanisms, optionally including programmable logic, may also be employed to provide a human-to-electronics interface. In an alternative embodiment, the control logic 900 is a programmable electronic component that controls the light source 300 according to a lighting control program. One or more lighting control programs may be stored in the control logic 900 and retrieved manually or automatically, e.g., using a timer or a sensor.

The control logic 900, in one embodiment, is addressable either with a hardware address or a network address. A hardware address is a physical address, while a network address is a logical address. A hardware address may be user-configurable (e.g., using dual-inline packing (DIP) switch) or may be set during manufacturing. In some embodiments, being able to address the control logical 900 with either a hardware address or network address is advantageous, as will be described later.

FIG. 10B illustrates another embodiment of the present invention, in which an interface 1900 is added to the wall plate assembly 1901. The interface 1900 is adapted to at least receive light source control data (not shown) for controlling the light source 300. The interface 910 may be physically adapted to receive the light source control data via a wired communications pathway, such as twisted-pair, or alternating current (AC) power line pathway (e.g., house wiring). Alternatively, the interface 910 may be physically adapted to receive light source control data via an optical wireless communications pathway, such as infrared (IR), or via radio frequency (RF), such as BLUETOOTH®. The interface 910 may be further adapted to receive lighting control data communicated using a communications protocol, such as, Electronic Industries Association (EIA)-232, United States Institute for Theatre Technology (USITT) Digital MultipleX (DMX)-512, X-10, or Internet Protocol (IP), to name a few.

FIG. 10C illustrates an embodiment of the present invention in which the light control data or image control data are received via a network 2900. In FIG. 10C, the network 2900 supports communications to or between a first wall plate assembly 2905 having a first network address and a second wall plate assembly 2910 having a second network address. The network 2900 may be internetworked with other networks 2915 in a Local Area Network (LAN) or a Wide Area Network (WAN), such as the Internet. Residing on either network 2900 or on one of the other networks 2915 is a light or image control server 2920. The light or image control server 2920 may store and transmit light or image control data to the wall plate assembly. Light or image control data sent by the light or image control server 2920 addressed with first or second network address directed to the first or second Wall plate assembly 2905, 2910, respectively, with the corresponding hardware or network address. Alternatively, a broadcast address can be used in a message, which results in the delivery of the message to all wall plate assemblies on the network.

The light source 300 may be configured to be powered by a line voltage associated with the light switch 105 and electrical outlet 110 (FIG. 1). The associated line voltage may be transformed (e.g., transformed from 120 volts to 12 volts). Alternatively, the light source 300 may be configured to be powered by a self-contained source of power, such as a dry cell battery. Consequently, there may be additional circuitry, such as an AC-to-DC converter, voltage reduction circuitry, a power regulator, etc., applicable for safe operation of the light source 300.

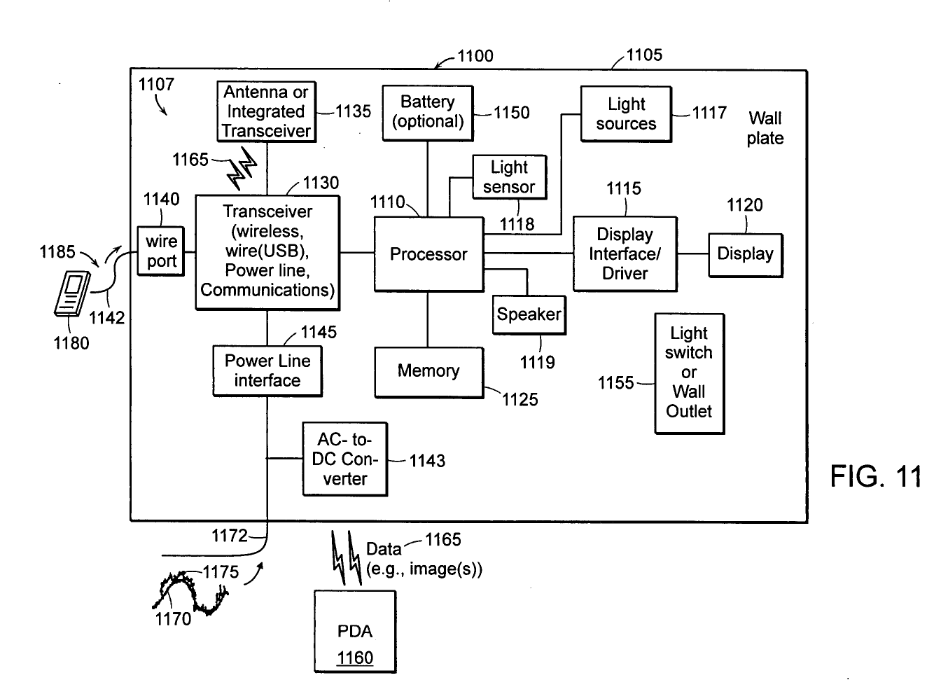

FIG. 11 is a block diagram of an example wall plate assembly 1100 that includes a wall plate 1105 and electronics 1107 and is mechanically configured to be arranged with a light switch or wall outlet 1155. The electronics 107 may include a processor 1110, display interface/driver 1115, display 1120, light source(s) 1117, memory 1125, transceiver 1130, antenna or integrated transceiver 1135, wire port 1140, power line bus interface 1145, and AC-to-DC converter 1143.

The electronics 1107 may also include a light sensor 1118 and speaker 1119. Also depicted in FIG. 11 is a Personal Digital Assistant (PDA) 1160 and a controller 1180. The PDA 1160 or PDA 1180 may be in the form of or integrated into a wireless remote control unit, typically used for operation with a television or VCR.

The wall plate 1105 may also include a battery 1150 that provides power to the electronics 1107 if power from a power line 1172 is interrupted and the AC-to-DC converter 1143 cannot provide DC power to the electronics 1107. For example, as described above, the wall plate 1105 may become illuminated in event of an emergency, such as a power outage. In this case, the processor 1110 may detect a power line interruption, activate the battery 1150, and use power from the battery 1150 to illuminate the wall plate 1105 with a safety light setting through activation of the light source(s) 1117.

In operation, the electronics 1107 may be configured to perform functions associated with illumination of the wall plate 1105 and display of images that may be illuminated by the light source(s) 1117. To perform these functions, the processor 1110 may execute lines of instructions, which are written in a software language executable by the processor 1110. The lines of instructions may be stored in the memory 1125, loaded, and executed by the processor 1110.

The processor 1110 may be programmed to cause the light source(s) 1117 to illuminate the wall plate 1105 during times the wall plate assembly 1100 is connected to the power line 1172, during times when a light sensor 1118 detects that ambient light is not present in a room in which the wall plate assembly 1100 is deployed, during times there is sound in the room as identified via a sound sensor (not shown) to save on energy or battery power, or other times, optionally user selectable via the controller 1180 or PDA 1160. The processor 1110 may also be programmed to display photographs, graphics, or other imagery on the display 1120 via the display interface/driver 1115. For example, the memory 1120 may also include data of photographs in album format, and the processor 1110 may constantly place photographs in sequence or randomly on the display 1120 for display via the wall plate 1105.

The processor 1110 may also be programmed to receive display data via the transceiver 1130 through any of the interfaces with which the transceiver is coupled, such as a wired interface via the wire port 1140, wireless interface via the antenna or integrated transceiver 1135, or power line 1172 via the power line bus interface 1145. For example, the antenna 1135 may receive data (e.g., images) 1165 on RF communications via an air interface, images 1185 via a wire bus 1142 through the wire port 1140, or power line communications 1175 that ride on a power line 120 volt AC waveform 1170. In each of these cases, the transceiver 1130 may perform the necessary conversions of the data formats through the wireless, wired, or power line data formats into a digital format that the processor 1110 can further process or simply pass through to the display interface/driver 1115 for presentation on the display 1130 to a person viewing the wall plate 1105.

The processor 1110 may also be programmed to receive control signals that cause the light source(s) 1117 to change dynamically, such as turning on and off lights in sequence, in random order, turning on multiple colors, single colors, subsets of light sources, incandescent lights and LEDs, or only LEDs, changing colors based on a season or other criteria (e.g., red and green between Thanksgiving and Christmas or red on Valentine's Day, and so forth), or any other way in which the light sources may be controlled to provide a unique lighting experience for a person viewing the wall plate 1105. In this way, with the light source(s) 1117 arranged in a lighting array or pattern, it is possible to create a custom scripted lighting array or pattern.

It is also possible for the processor 1110 to be programmed to change a physical feature of the wall plate assembly 1100, such as causing a mechanical change in the wall plate 1105, which may cause a corresponding change in the way light is internally reflected in the wall plate 1105. For example, there may be small actuators or motors (not shown) integrated into the wall plate 1105 that change orientation of mirrors (not shown) that the light source(s) 1117 may direct light toward. In one such embodiment, the actuated mirrors may allow the light from the light source(s) 1117 to pass directly through the front of the wall plate 1105 in a first mirror orientation, and, in a second mirror orientation, the actuated mirrors may cause the light to reach an angle of total internal reflection and be projected outward through edges of the wall plate 1105. The actuators or motors may also be coupled to other components of the wall plate 1105 to produce other light-related or non-light-related effects.

It should be understood that the processor 1110 can be programmed in almost any conceivable way to produce interesting and useful effects in lighting or display of images by the wall plate assembly 1100 and also be programmed in ways that allow for a variety of communications with the outside world. For example, the processor 1110 may be programmed to respond to messages or signals having a destination specified for a particular hardware address or Internet Protocol (IP) address. The processor 1110 may also be programmed to identify a person viewing the wall plate 1105 based on information “sniffed” from the PDA 1160, the person's cell phone, or other personal communications device (not shown). Moreover, it is contemplated that the processor 1110 can be programmed to automatically communicate and receive or exchange information with a wireless device that searches for other wireless devices to which to transfer data, such as photographs, information associated with the person carrying the wireless device, and so forth. Moreover, the processor 1110 may also be programmed to generate sounds via a speaker 1119, such as bird sounds, waterfall sounds, ocean waves, and so forth, independent of lighting effects or displayed images or in synchronous relationship with the lighting effects or displayed images. Thus, it should be understood that the processor 1110 may be programmed to perform a variety of features that are suitable or desirable for presentation by the wall plate assembly 1100.

While this invention has been particularly shown and described with references to preferred embodiments thereof, it will be understood by those skilled in the art that various changes in form and details may be made therein without departing from the scope of the invention encompassed by the appended claims.

For example, in emergency settings, the lights may illuminate RED in or outside a room in which it is not safe to enter; GREEN in or outside a room safe to enter; or illuminate an arrow to direct people to a fire exit in the event of a fire. Since the switch plate or wall outlet cover plate may be configured to install into existing wall sockets and may simply display light through a plastic, glass, or other medium, it is easy for an “older” building to be retrofitted with such emergency assistance mechanisms supported by such embodiments of the present invention.

Some embodiments may be associated with different lighting markets. For example, when the power is on, the wall plate light is functioning, and the wall plate may be considered part of the “accent lighting” market; if power goes off and the wall plate light comes on, the wall plate may be considered part of the “emergency lighting” or “task lighting” market. Neon lighting or other forms of lighting that can be found in either market or other markets known in the art may also be employed.

An optional layout arrangement can include installing all lighting/hardware/electronics components other than the wall plate in a junction box (J-BOX) mounted in the wall (in any switch or electrical outlet arrangement). The light display may be projected into the wall plate and directed in a direction observable by a person, as described above.

The principles of the present invention may include taking commonly accepted wall plate sizes and producing the wall plate according to various embodiments described above at these sizes. This applies not only to residential venues but also to corporate and institutional settings. Furthermore, abstract shapes can be developed that are rectilinear in shape, curvilinear in shape, or a combination thereof, adding to the variety of lighting experiences made possible by the application of LED (or other light generating technology) and precision injection molded plastic castings.

Materials such as polycarbonates may be used in combination with sandblasting to achieve certain lighting effects. It should be understood that materials other than plastics, such as quartz rock, glass, hardened resins, sodalime glass, and so forth, may also be used as a base material for the wall plate.

Any number of microprocessors, digital logic, or analog circuitry may be used. For example, two microprocessors per wall plate assembly may be employed: one that governs the lighting, sequencing, timing, coloring, and the like, of the light source, and the other that governs the displaying of images by the dynamic image unit. One or more microprocessors may have intelligence to dynamically change the lighting or displayed image(s).

Firmware, software, or hardware may be used to control any of the microprocessors, lights, or other functions (e.g., sound). For example, hardware for controlling an LED may be integrated into the base of the LED. In another example, different processing may be used for different environments, such as processing that applies to commercial or industrial settings (e.g., light sensor or emergency color displays) and processing that applies to a residential setting (e.g., art or task list).

What is claimed is:

1. A wall plate assembly comprising:
a light source; and
a wall plate configured to be arranged with a wall mounted switch or electrical outlet, and having a front surface, observable by a person, and a rear surface, the wall plate further configured to: (i) receive light from the light source, (ii) reflect at least a portion of the received light off an internal side of the front surface of the wall plate, and (iii) direct at least a portion of the internally reflected light in a direction observable to the person.

2. The wall plate assembly of claim 1 wherein the light source includes at least one light emitting diode (LED).

3. The wall plate assembly of claim 1 further comprising an image illuminated by the internally reflected light.

4. The wall plate assembly of claim 3 wherein the illuminated image is applied to the wall plate and is selected from a group consisting of: an image adhered to a surface of the wall plate, a sculpted image extending outwardly from the surface of the wall plate, a sculpted image extending inwardly from the surface of the wall plate, an image printed on the surface of the wall plate.

5. The wall plate assembly of claim 3 wherein the illuminated image is applied dynamically.

6. The wall plate assembly of claim 3 further comprising electronics configured to control an appearance of the illuminated image and to receive data from an external electronic device, the electronic device using the received date to control the appearance of the illuminated image.

7. The wall plate assembly of claim 1 wherein the wall plate and the internally reflected light combine to be expressive to the person observing the wall plate and whose expressive quality is created in part by at least one physical characteristic of the wall plate, the at least one physical characteristic selected from a group consisting of: shape, dimension, material, optical characteristics, and texture.

8. The wall plate assembly of claim 1 further comprising control logic programmed to control the light source.

9. The wall plate assembly of claim 8 wherein the control logic is addressable by a remote network node via a network communications path and programmable or configurable by the remote network node.

10. The wall plate assembly of claim 8 further comprising an interface adapted to receive light source control data from an electronic device via at least one of the following communications paths: radio frequency (RF) wireless, optical wireless, wired, or power line.

11. The wall plate assembly of claim 1 wherein the light source is adapted to be powered by at least one of the following sources of power: line voltage associated with the wall mounted switch or electrical outlet, transformed line voltage, rectified line voltage, or self contained power source.

12. A method for illuminating a wall plate for a wall mounted switch or an electrical outlet, the method comprising:
generating light;
reflecting at least a portion of the generated light off an internal side of a front surface of a wall plate; and
directing at least a portion of the internally reflected light in a direction observable to a person.

13. The method of claim 12 further comprising illuminating an image with the internally reflected light.

14. The method of claim 13 wherein illuminating the image includes illuminating the image in a manner that causes light illuminating the image to be redirected to the surface of the wall plate without being further internally reflected.

15. The method of claim 13 wherein illuminating the image includes displaying the illuminated image dynamically.

16. The method of claim 12 further comprising combining the wall plate and internally reflected light in a manner expressive to the person observing the wall plate and whose expressive quality is created in part by at least one physical characteristic of the wall plate, the at least one physical characteristic selected from a group consisting of: shape, dimension, material, optical characteristics, and texture.

17. The method of claim 12 further comprising selectively controlling the light source.

18. The method of claim 17 wherein selectively controlling the light source includes applying data received from an external electronic device to the light source.

19. The method of claim 12 further comprising dynamically changing an image illuminated by the light source.

20. An apparatus, comprising:
means for generating light;
means for reflecting at least a portion of the generated light off an internal side of a front surface of a wall plate configured to be arranged with a wall mounted switch or an electrical outlet; and
means for directing at least a portion of the internally reflected light in a direction observable to a person.
